(19) United States
(12) Patent Application Publication
(10) Pub. No.: US 2009/0295566 A1
(43) Pub. Date: Dec. 3, 2009

(54) Apparatus and Method for The Detection of a Subject in Drowning or Near-Drowning Situation

(76) Inventor: Eitan Weintraub, Yavne (IL)

Correspondence Address: EITAN MEHULAL LAW GROUP, 10 Abba Eban Blvd. PO Box 2081, Herzlia, 46120, IL

(21) Appl. No.: 12/087,410

(22) PCT Filed: Jan. 4, 2007
(86) PCT No.: PCT/IL07/00011

§ 371 Date: Oct. 2, 2008

(30) Foreign Application Priority Data
Jan. 4, 2006 (IL) 172979

(51) Int. Cl. G08B 1/08; G08B 23/00

(52) U.S. Cl. 340/539.11; 340/573.6

(57) ABSTRACT

An apparatus and method for the early detection of a subject in a drowning or in a near-drowning situation in a body of water, such as a swimming pool, are disclosed. When the drowning or near-drowning situation is identified the apparatus issues an alarm signal that, in order to promote early rescue, attracts the relative, guest, friend or any other person. Following the identification of the alarm signal the potential rescuer is capable of initiating an immediate rescue operation and consequently requisite emergency medical procedures.

### BACKGROUND OF THE INVENTION

1. Field of the Invention

The present invention relates to an apparatus, system and method for the detection and indication of a subject in a drowning or near-drowning situation in a body of water, and more particularly to an apparatus and method that generate and transmit alarm signals to potential rescuers consequent to the early detection of a subject in a drowning or near-drowning situation in a body of water.

2. Discussion of the Related Art

Drowning is defined as death secondary to asphyxia while immersed in water or any other liquid. Near drowning connotes an immersion episode of sufficient severity to warrant medical attention that may lead to irreversible brain damage, morbidity and death. About 8000 drowning deaths occur in the United States every year, and an estimated 150,000 worldwide. Most of the victims are either young children or young adolescents. Among children in the ages 14 and below drowning follows car accidents as the second leading cause of unintentional injury and death. Surveys indicate that 10% of children under 5 experienced a situation with a high risk of drowning.

According to recent estimates there are about 7 million residential pools in the continental United States. On average each year 350 children under the age of 5 years drown in swimming pools with most deaths occurring in residential settings. In addition, each year, on average, another 2,500 children under five years of age are treated in hospital emergency rooms for near-drowning incidents in swimming pools. About 78 percent of these incidents occur at a home location.

In order to affect efficient rescue many pools and designated bathing areas employ certified professional lifeguards. Bystanders also play an important role in drowning detection with or without the presence of lifeguards by either actual intervention or by the notification of the lifeguards or other authorities by phone or alarm. In private/home location/residential pools typically parents, relatives, grown-up siblings, adult guests or any other suitable individuals present take on the life guarding or supervisory roles.

Life guarding and/or close supervision is the primary means of preventing aquatic accidents. Since every second counts in a drowning incident life guarding demands that one be constantly alert for any dangers to the persons in the area under supervision. While performing surveillance, lifeguards try to prevent drowning or other injury and death by looking for drowning or near-drowning related signals among the subjects. Such signals may appear at any time, so a lifeguard must be on constant alert in order be ready to pull someone from the water and possibly perform rescue.

A serious problem with life guarding is that lifeguards even when fully alert can monitor only limited portion's of the swimming pool. Moreover, a subject can sink beneath the surface of the water without being detected even by an alert lifeguard. Once, a person sinks beneath the surface of the water it is unlikely that a lifeguard can become aware of the submerged person. The problem becomes more acute by the fact that drowning and particularly the drowning of a child typically occur very quickly and quietly in a matter of seconds. The classic image of a victim helplessly gasping and thrashing in the water is rarely reported. A more frequent scenario of a motionless individual floating in the water or quietly disappearing beneath the surface is more typical. Even a momentary lapse of supervision, for example, if a parent is momentarily distracted by another child could be a significant factor in most drowning or near-drowning situations. Parents whose children had drowned testify that no matter how or where the drowning happened, such as a pool, sea or any other body of water, the seconds that claimed the child's life slid by silently and without warning.

Technology can assist in the fight against children drowning. In recent years there has been a huge increase in the demand for swimming pool alarms in the USA and Europe. While no product can ever take the place of constant adult supervision around water, pool alarms offer an additional layer of protection to further reduce the possibility of drowning. If a child somehow manages to get past a parent and reach the water, the alarm will sound in time to prevent a tragedy.

The use of pool alarms is known in the prior art. Pool alarms are available in different forms, each with their own distinct advantages and disadvantages. Some raise alarm whenever anyone enters the pool area, when others only sound when a child falls into water. The majority of the current systems could be defined as pool area-intrusion or water-intrusion detection systems. These are divided into three technical categories: a) Systems that are based on surface wave sensors, b) Systems that are based on surface disturbance sensors and c) Systems that are based on water exposure sensors. The disadvantage of all these systems lies in their limited objectives and consequently their detection capability limitations. Almost the entire range of pool alarm systems protects only against unauthorized intrusion to the swimming pool area or unauthorized entry into the water. The overwhelming majority of the swimming pool alarms are not designed and therefore incapable of identifying a drowning person during active swimming.

The Poseidon System developed by Vision IQ is a more advanced pool alarm system that does attempt to identify a drowning person in active swimming. The system includes a pool safety camera system which consists of a network of underwater cameras, overhead cameras, a central processor, alarm pagers, and a supervisory workstation. The cameras are mounted in the pool below and above the surface of the water. The cameras are linked to the central processor that processes the images in order to monitor the trajectories of the subjects and to analyze in real time, their activity. The system can automatically identify suspicious situations such as a person who is motionless underwater. Subsequently the system alerts lifeguards via the alarm pagers or the supervision workstation. The major disadvantages of the above system concern the sophistication and therefore the high price of the equipment, the complexity of the installation, the difficulty of operating, and the high expenses involved in the maintenance. In addition the system is basically stationary, difficult to port and therefore mainly suitable for large public swimming pools.

It would be easily perceived by one with ordinary skills in the art that there is a need for an advanced, cost-effective, quickly installable, easily operated, substantially portable and minimum-maintenance pool safety apparatus and method for the early identification of a drowning person among the regular subjects while the swimming pool is in active use. Such an apparatus and method should be suitable for public pools as well as for private/home location/residential pools, or bathing areas associated with any other body of water, such as a sea, a lake, or a river.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

In some embodiments there is provided a wearable apparatus for the detection of a subject in a drowning or near-drowning situation, the apparatus comprising a detection unit adapted to detect at least one body movement related parameter and at least one environmental parameter and a controller adapted to receive data from the detection unit and to generate an alarm signal upon determination that the subject is in a drowning or near-drowning situation. The controller may further adapted to generate a wet alarm upon determination that the subject is in the water.

According to some embodiments, there is further provided a system for the detection of a subject in a drowning or near-drowning situation, the apparatus comprising a wearable apparatus comprising a detection unit adapted to detect at least one body movement related parameter and at least one environmental parameter and a controller adapted to receive data from the detection unit and to generate an alarm signal upon determination that the subject is in a drowning or near-drowning situation and a receiver adapted to receive the alarm signal and to output (for example directly and or by a workstation or any other element) an alarm upon receiving the alarm signal.

There is further provided according to some embodiments, a method for the detection of a subject in a drowning or near-drowning situation, the method comprising detecting at least one body movement related parameter and at least one environmental parameter and generating an alarm signal upon determination that the subject is in a drowning or near-drowning situation.

According to some embodiments, the apparatus may be adapted to work in at least two modes of operation. The first mode of operation produces an alarm signal when the subject wearing the apparatus enters the water and the second mode of operation produces an alarm signal when the subject wearing the apparatus is in a drowning or near-drowning situation.

One aspect of the present invention regards an apparatus for the early detection of a subject in drowning or near-drowning situation in a body of water and for the issuing of an alarm signal in order to indicate the drowning or near-drowning situation. The apparatus comprises an alarm device attached to a part of the subject's body for measuring environmental variables when the body of the subject is submerged under water, for processing the values of the environmental variables, for determining whether the subject is in a drowning or near-drowning situation based on the result of the processing and for issuing an alarm signal indicating drowning or near-drowning situation, a receiver device located in the vicinity of the body of water for receiving the alarm signal issued by the alarm device, for detecting the alarm signal, for generating an alarm and for outputting the alarm.

Another aspect of the present invention regards a method for detecting a subject in drowning or near-drowning situation in a body of water and for issuing an alarm signal in order to indicate the drowning or near-drowning situation. The method comprises activating an alarm device when the alarm device is submerged for a pre-defined number of seconds, measuring environmental variables while the alarm device is submerged and active, processing the environmental variables for the detection of a drowning or a near-drowning situation of the subject, and releasing a float unit having positive is buoyancy and incorporating a radio frequency transmitter from the alarm device for enabling radio frequency transmission of alarm signals indicating a drowning or near-drowning situation of the subject.

In addition to the exemplary aspects and embodiments described above, further aspects and embodiments will become apparent by reference to the figures and by study of the following detailed descriptions.

### BRIEF DESCRIPTION OF THE DRAWINGS

The present invention will be understood and appreciated more fully from the following detailed description talcen in conjunction with the drawings in which:

FIG. 1 is a pictorial representation of a subject during active swimming and using the pool alarm apparatus and device, in accordance with some preferred embodiments of the present invention;

FIG. 2 is a pictorial representation of a subject in a drowning or near-drowning situation after the pool alarm apparatus detected and indicated the situation thereof, in accordance with some preferred embodiments of the present invention;

FIG. 3A is a pictorial representation of the wearable pool alarm device, in accordance with a first preferred embodiment of the present invention;

FIG. 3B is a pictorial representation of the wearable pool alarm device, in accordance with a second preferred embodiment of the present invention;

FIG. 4A is a block diagram showing the structure and the principal components of the pool alarm device, in accordance with the first preferred embodiment of the present invention;

FIG. 4B is a block diagram showing the structure and the principal components of the pool alarm device, in accordance with the second preferred embodiment of the present invention;

FIG. 5 is a block diagram showing the functional components of the base unit of the pool alarm device, in accordance with the second preferred embodiment of the present invention;

FIG. 6 is a block diagram showing the functional components of the float unit of the pool alarm device, in accordance with the second preferred embodiment of the present invention;

FIG. 7 is a block diagram showing the functional components of the receiver unit of the pool alarm apparatus, in accordance with some preferred embodiments of the present invention;

FIG. 8 is a block diagram showing the functional components of the supervisory workstation of the pool alarm apparatus, in accordance with some preferred embodiments of the present invention;

FIGS. 9A and 9B are flowcharts describing the logic of the operation of the pool alarm device, in accordance with some preferred embodiments of the present invention; and

FIG. 10 is a schematic illustration of a graph of movement commencements as a function of time in accordance with some demonstrative embodiments of the invention.

### DETAILED DESCRIPTION

An apparatus and method for the early detection of a subject in a drowning or in a near-drowning situation among a plurality of regular subjects in a body of water, such as a swimming pool, and the detection of entry to water if there was no intention to enter are disclosed.

When the drowning or near-drowning situation is identified the apparatus issues an alarm signal that, in order to promote early rescue, attracts the attention of a potential rescuer, such as a professional lifeguard, parent, relative, guest, friend or any other person. The person could be present in the vicinity of the body of water for actively supervising the activity of the subjects or could be present for sports or recreation and could identify the alarm signal by being near to the body of water. Following the identification of the alarm signal the potential rescuer could initiate an immediate rescue operation and consequently requisite emergency medical procedures.

The apparatus consists of a wearable, portable pool alarm device attached to a body part of the subject, a receiver device in the vicinity of the body of water and a workstation of a supervisor linked to the receiver. The wearable pool alarm device includes environmental sensors to measure in combination variables that indicate entry to water, drowning or near-drowning situation of the subject wearing the device. The sensors in combination feed sensor information to a controller, such as a microcontroller or any other computing and switching device installed in the device to enable device-specific operations, such as logical steps, calculations or unique switching states that indicate the situation of the subject wearing the device. When the result of the device-specific operations points to a drowning or near-frowning situation of the subject, the microcontroller or the switching device affects the release of an alarm signal for example, by a transmitter and/or the release of a float device attached to the pool alarm device having positive buoyancy and incorporates transmitter. The transmitter may be adapted to transmit a radio frequency, ultrasonic and/or sonic signals. In may be noted that in cases where the transmitter is adapted to transmit ultrasonic and/or sonic alarm signals there the apparatus may be operated without releasing a float device since the ultrasonic and sonic signals can pass through water. In order to facilitate ultrasonic and/or sonic signal transmission through water the receiver and/or an antenna thereof may be placed inside the water. The float device rises to the surface of the body of the water while carries the transmitter incorporated therein and the alarm signal is propagated within an area of reception in the vicinity of the swimming pool. The receiver receives and processes the signal and consequently generates and sends an alarm signal to the supervisory workstation. The alarm signal produces highly audible audio signaling and optionally a video signaling, light signaling and/or other indications to attract the attention of the potential rescuer to the situation of the subject. Subsequent to the identification of the audio signal the potential rescuer, such as a lifeguard, parent, and the like, initiates a rescue and emergency medical treatment procedure concerning the subject in the drowning or near-drowning situation.

In some preferred embodiments of the present invention the body of water is a residential swimming pool. Accordingly the apparatus that is presented in the text of this document is a substantially minimal configuration of the proposed invention, such as one pool alarm device, one receiver and one supervisory workstation operating locally. In some embodiments, the receiver and the workstation may be two functions of one device, for example in one compact arrangement. Note should be taken that in other preferred embodiments of the present invention, the apparatus proposed could be installed in various larger configurations, such as a plurality of alarm devices wore by a plurality of subjects, potentially issuing a plurality of alarm signals to a plurality of receivers. In some preferred embodiments of the present invention the body of water is associated with a residential swimming pool. In other preferred embodiments the body of water could be a public swimming pool, a lake, a sea, an ocean, a river and the like. The term “subject” as referred to herein may include a human being such as a child, an adult or a toddler or to an animal, such as a pet animal. In a preferred embodiment of the invention the subjects, such as persons, in the body of water may be swimming for sport, or recreation while in other preferred embodiments the subjects in the water could be boating, waterskiing, diving, flying above water, parachuting into water, or engaged in a plurality of other aquatic sport-related or aquatic profession-related activity.

The proposed apparatus is substantially simple, small, portable, efficient and inexpensive. Installation is quick and easily accomplished. The apparatus could be moved from one bathing area to another, such as from one residential pool to another in the same neighborhood in a matter of minutes (dependant on the distance). No specific enclosures or holders are needed for the installation of the units. Configuring the apparatus is straightforward and the maintenance of the equipment is easy for most of the mechanical, electric and electronic components constituting the apparatus are standard and well-known. All the components are small-sized therefore transportation is easy. The power consumption of the apparatus is low. The apparatus could be quickly installed in boats, in airplanes, and in practically any bathing area, could be tested in a short time and could be ready to be used almost immediately.

In some embodiments there is provided a wearable apparatus for the detection of a subject in a drowning or near-drowning situation, the apparatus comprising a detection unit adapted to detect at least one body movement related parameter and at least one environmental parameter and a controller adapted to receive data from the detection unit and to generate an alarm signal upon determination that the subject is in a drowning or near-drowning situation. The controller may further adapted to generate a wet alarm upon determination that the subject is in the water.

The apparatus may be adapted to operate in at lease two modes. In a first mode of operation the controller is further adapted to generate a wet alarm upon determination that the subject wearing the apparatus is in the water. This mode of operation may include detecting an environmental parameter, which is in this case being in a media of water, and generating an alarm signal upon determination that the subject is in the water. The second mode of operation produces an alarm signal when the subject wearing the apparatus is in a drowning or near-drowning situation.

The apparatus may further include a transmitter adapted to transmit the alarm signal. The transmitter may be adapted to transmit a radio frequency, a sonic or an ultrasonic alarm signal.

The apparatus may further include a marker-releasing unit adapted to release a marker as the alarm signal. The marker may visually indicate that the subject is in a drowning or near-drowning situation. The marker may include a dye, a pigment, a coloring agent or any combination thereof.

The apparatus may further include a float unit adapted to be released from the apparatus upon indication from the controller of the subject being in a drowning or near-drowning situation. The float unit may include a buoyancy canister to provide positive buoyancy. The float unit may include a transmitter adapted to transmit the alarm signal. The float unit may include a marker-releasing unit adapted to release a marker as the alarm signal. The marker may visually indicate that the subject is in a drowning or near-drowning situation. The marker may include a dye, a pigment, a coloring agent or any combination thereof. The float unit may include the controller. The float unit may include the detecting unit. The float unit may include an antenna adapted to propagate said alarm signals. The float unit may include a power source.

The detection unit may include a water sensor. The water sensor may be adapted to detect when the apparatus and thus the subject is in water. The detection unit may include a movement sensor. The movement sensor may be adapted to detect any type of active movement (such as movements of arms legs and the like) in a subject. The detection unit may include a hydrostatic pressure sensor, a hydrodynamic pressure sensor or both. The detection unit may include a strain-gauge sensor. The detection unit may include an inclinometer. The detection unit may include a barometer.

The apparatus may further include a release unit for releasably connecting the float unit to the apparatus. The release unit may include an electro mechanical apparatus. The release unit may include magnetic device. The release unit may include a mechanical device.

The apparatus may further include a micro-switch adapted to activate the float unit consequent to separation from the apparatus. The apparatus may further include a power source to provide electric power to the apparatus.

The apparatus may further include an attachment unit adapted to attach the apparatus to the subject, for example to the arm; leg, waist, chest or any other part of the body.

The apparatus may further include a base unit adapted to connect to an attachment unit and releasably connect to the float unit. The base unit may include a transmitter adapted to transmit the alarm signal. The base unit may include the marker-releasing unit. The base unit may include the controller. The base unit may include an antenna adapted to propagate the alarm signals. The base unit may include an antenna adapted to propagate the alarm signals.

The apparatus may further include a press-button adapted to test at least one function of the apparatus. The apparatus may further include a press-button adapted to release the float unit from the apparatus.

The apparatus may further include a Global Positioning System adapted to provide information related to the location of the subject.

The apparatus may be adapted to be attached to a wrist of the subject. The apparatus may be an integral part of a water-proof wristwatch.

The apparatus may be adapted detect a subject in a drowning or near-drowning situation in body of water. The body of water may be a residential swimming pool, public swimming pool, river, lake, pond, water reservoir, sea or an ocean.

The detection unit may be adapted to identify a passive movement of the subject. The detection unit may be adapted to differentiate between an active movement of the subject and a passive movement of the subject associated by at least one of a wave or a current. The detection unit is adapted to count movement commencements of the subject within pre-defined time periods, and to determine that the subject is in a drowning or near-drowning situation if a number of movement commencements within the pre-defined time period is smaller than a threshold value. The detection unit is adapted to determine that a first number of movement commencements occur within a first time period, and to determine that a second number of movement commencements occur within a second time period, wherein the first time period and the second time period are substantially equal. The detection unit may be adapted to determine that the subject is in drowning or near-drowning situation based on a calculation taking into account at least the first number of movement commencements and the second number of movement commencements. The detection unit may be adapted to determine that the subject is not in drowning or near-drowning situation if the second number of movement commencements is smaller than the product of: the first number of movement commencement multiplied by a pre-defined positive number greater than one.

According to some embodiments, there is further provided a system for the detection of a subject in a drowning or near-drowning situation, the apparatus comprising a wearable apparatus comprising a detection unit adapted to detect at least one body movement related parameter and at least one environmental parameter and a controller adapted to receive data from the detection unit and to generate an alarm signal upon determination that the subject is in a drowning or near-drowning situation and a receiver adapted to receive the alarm signal and to output (for example directly and or by a workstation or any other element) an alarm upon receiving the alarm signal.

The receiver may be adapted to receive a radio frequency signal, a sonic, an ultrasonic signal or any combination thereof. The receiver may be placed outside the body of water, for example, in the case of radio frequency signals, or inside (or at least partially inside) the body of water, such as in the case of sonic, an ultrasonic signals.

The receiver may be adapted to transmit an alarm signal to a workstation, to another receiver, such as a remote receiver or to both. The receiver may be adapted to transmit an alarm signal to a workstation, a remote receiver or both in a wired or wireless manner. The workstation may be adapted to output an alarm upon receiving the alarm signal. In some embodiments the receiver and the workstation may be included in one device.

The alarm may include an audio alarm, a visual alarm (such as an electronic billboard including for example video, text and/or light(s)) and/or a vibration alarm (such as a receiver or a device functionally associated to the receiver that is adapted to alert a supervising person by a vibration alarm that subject entered the water or is in a drowning or near-drowning situation). The alarm may include any combination of alarm types.

There is further provided according to some embodiments, a method for the detection of a subject in a drowning or near-drowning situation, the method comprising detecting at least one body movement related parameter and at least one environmental parameter and generating an alarm signal upon determination that the subject is in a drowning or near-drowning situation.

The method may further include releasing a float unit from the apparatus upon indication from the controller of the subject being in a drowning or near-drowning situation. The method may further include transmitting the alarm signal to a receiver by radio frequency, sonic or ultrasonic technology alarm signal. The method may further include releasing a marker-releasing unit to indicate that a subject is in a drowning or near-drowning situation. The marker may include a dye, a pigment, a coloring agent or any combination thereof. The method may further include outputting an alarm to indicate that a subject is in a drowning or near-drowning situation. The alarm may include any of the features described herein, for example, an audio alarm, a visual alarm, a vibration alarm or any combination thereof. The method may further include transmitting an alarm signal from the receiver to a workstation, to another receiver, such as a remote receiver or to both. The method may further include outputting an alarm upon receiving the alarm signal to indicate that a subject entered the water and/or is in a drowning or near-drowning situation.

According to some embodiments, the apparatus may be adapted to work in two modes of operation. The first mode of operation produces an alarm signal when the subject wearing the apparatus enters the water. This mode of operation may include detecting an environmental parameter, which is in this case being in a media of water, and generating an alarm signal upon determination that the subject is in the water. This mode may allow, for example, a parent to monitor a child that is playing outdoors but is not allowed to go into the swimming pool. Other examples may include any situation when there is no intention to enter into the water. In these cases the apparatus is adapted to issue an alarm signal that, in order to promote early rescue, may attract the attention of a potential rescuer, such as a parent, relative, guest, friend or any other person. The person could be present in the vicinity of the body of water for actively supervising the activity of the subject or could be doing other activity in the vicinity and could identify the alarm signal by being near to the body of water. Following the identification of the alarm signal the potential rescuer could initiate an immediate rescue operation and consequently requisite.

The second mode of operation produces an alarm signal when the subject wearing the apparatus is in a drowning or near-drowning situation. This mode of operation may include detecting at least one body movement related parameter and generating an alarm signal upon determination that the subject is in a drowning or near-drowning situation. This mode may be use, for example, by a parent to monitor a child that is going into the water. Of course other uses of the first and/or second modes of operation are covered under the scope of this disclosure.

In one embodiment of the invention, the term “near-drowning situation” as referred to herein may include a situation wherein a subject is entering a body of liquid, such as water, without intention. In another embodiment of the invention, the term “near-drowning situation” as referred to herein may include a situation wherein a subject such as a child, a toddler, an infant or a person having special needs is entering a body of liquid, such as water, without being supervised. In another embodiment of the invention, the term “near-drowning situation” as referred to herein may include a situation that may lead to drowning within a substantially short time or if no help and/or rescue arrive. The wearable apparatus may further include according to some embodiments a notification device adapted to notify the user that he/she has not moved over a predetermined period of time. The notification means may include for example vibration generator.

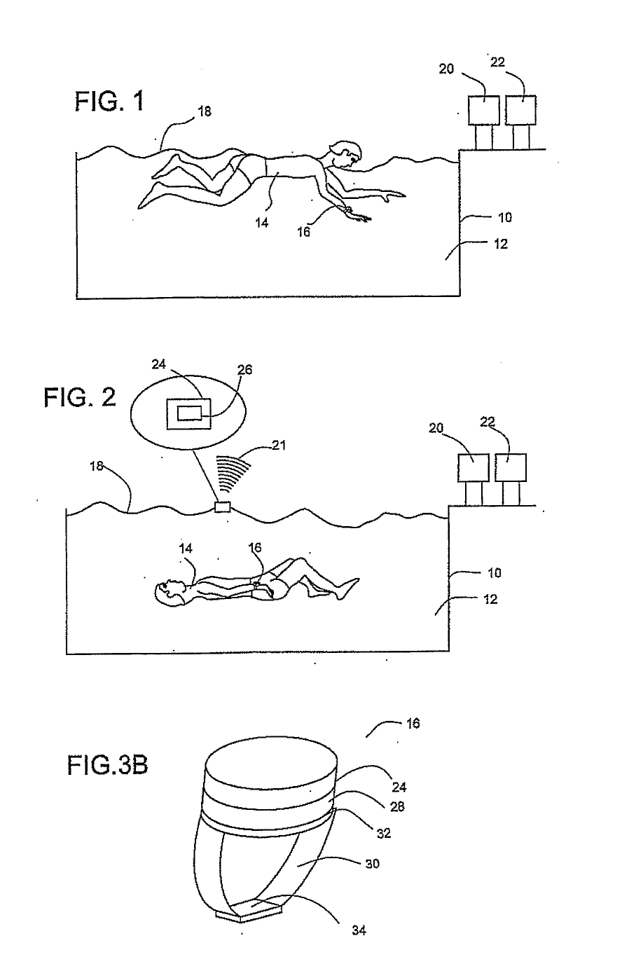

FIG. 1 shows the environment within which the proposed apparatus and method could operate, in accordance with a preferred embodiment of the present invention, wherein a subject 14 is shown during active regular swimming on, below or near the surface 18 of a body of water 12 enclosed within a swimming pool 10. Subject 14 wears, preferably at all times when in the water or near the water, a portable, wearable alarm device 16 on his wrist. Near the body of water 12 (or in some cases, in the body of water 12, for example when the receiver is ultrasonic and/or sonic) on the poolside area a wireless receiver unit 20 is located. Unit 20 is linked either in a wired or a wireless fashion to a supervisory workstation 22. It is noted that according to some embodiments, unit 22 and workstation 22 may be assembled in one device. Alarm device 16 is adapted to detect whether the subject enters the water and/or is in a drowning or near-drowning situation and to indicate the drowning or near-drowning situation by releasing an alarm signal, for example, by an ultrasonic (US) transmitter, a sonic, a radio frequency (RF) and/or by any other transmitter, optical communication means and/or by releasing a dye or a coloring agent to the water. Generally, ultrasonic and/or sonic transmission is more appropriate to transmission in the water, however, radio frequency (low frequency) may also be applied. According to other embodiments, alarm device 16 may be adapted to detect whether the subject enters the water and/or is in a drowning or near-drowning situation and to indicate the drowning or near-drowning situation by releasing (in addition to or instead of releasing an alarm signal) an attached float device 24 of FIG. 2 equipped with a transmitter 26 for example, a radio frequency (RF), an ultrasonic (US), a sonic transmitter and/or any other transmitter, of FIG. 2 to rise, to the surface 18 of the water or close to the surface 18 and to transmit alarm signals in a wireless manner to receiver 20. The alarm signals are modulated, for example, by regular RF modulation technologies, such as FM, AM, QPSK, and FSK or by ultrasonic and/or sonic modulation(s) where receiver 20 is within the signal reception zone of transmitter 26 of FIG. 2. Thus, receiver 20 is capable receiving the alarm signals from transmitter 26 of FIG. 2 and is adapted to transmit the alarm signals to supervisory workstation 22 in a wired or wireless manner. Workstation 22 is located preferably in the general vicinity a human supervisor, a dedicated lifeguard or other supervisory subject (not shown). Workstation 22 is adapted to respond to the reception of alarm signals from receiver 20, for example, by generating and outputting sufficiently loud audio alarm signals and optionally displaying a visual alarm consisting of images visually sufficiently outstanding in order to alert effectively the supervisory subject (not shown) as to the situation of the subject 14. In addition, workstation 22 could optionally transmit the received alarm signal in a wired or wireless manner to a remote device to allow the remote device to generate and output audio alarm signals and/or visual alarm signals at a remote location.

FIG. 2 shows the environment within which the proposed apparatus and method could operate, in accordance with some preferred embodiments of the present invention where subject 14 is in a drowning or near drowning situation within the body of water 12 in swimming pool 10. Subject 14 is submerged in the water and lies or floats on the surface, near the surface, near to the bottom or in any depth from the surface to the bottom of the pool 10 without substantial body movements. Consequent to the detection of the drowning or near-drowning situation by alarm device 16 attached to the wrist of the subject 14 a specifically adapted float device 24 is released from the alarm device 16 and rises to the surface 18 of the body of water 12 as a result of given positive buoyancy which is the upward force exerted on device 24 by the water. Float device 24 includes transmitter 26, such as a radio frequency (RF), an ultrasonic (US), a sonic transmitter and/or any other transmitter, which starts transmitting alarm signals 21 (such as radio frequency sonic and/or ultrasonic signals) immediately following the release of float device 24 from alarm device 16. When float device 24 reaches surface 18 and transmitter 26 installed therein rises above water level the wireless transmission becomes effective, such that receiver 20 receives the alarm signals 21. Consequently, receiver 20 transmits the alarm signals to the supervisory workstation 22 in a wireless or a wired manner. Workstation 22 produces and outputs signals such as strong audio signals and optionally displays highly noticeable video images in order to alert the supervisory subject, the lifeguard (not shown) in the most effective manner as to the situation of subject 14. As a result the lifeguard (not shown) could initiate urgent rescue procedures in order to remove the subject, such as subject 14 from the water and consequently to provide medical attention, First Aid, and the like, where needed. Note should be taken that float unit 24 and alarm device 16 could be physically connected at all times by an electrically conductive or electrically non-conductive extendable connecting wire. The connection and the connecting wire could be passive, such as a plastic line, with the functionality of guiding a potential rescuer to locate physically the subject in a drowning or near drowning situation by following the line extending from float unit 24 floating on the surface to alarm device 16 attached to subject 14. The connection and the connecting cable could be also active, such as an electrically conducting wire line that could enable a flow of electricity and/or a transmission of electric signals between the float unit 24 and the alarm device 16.

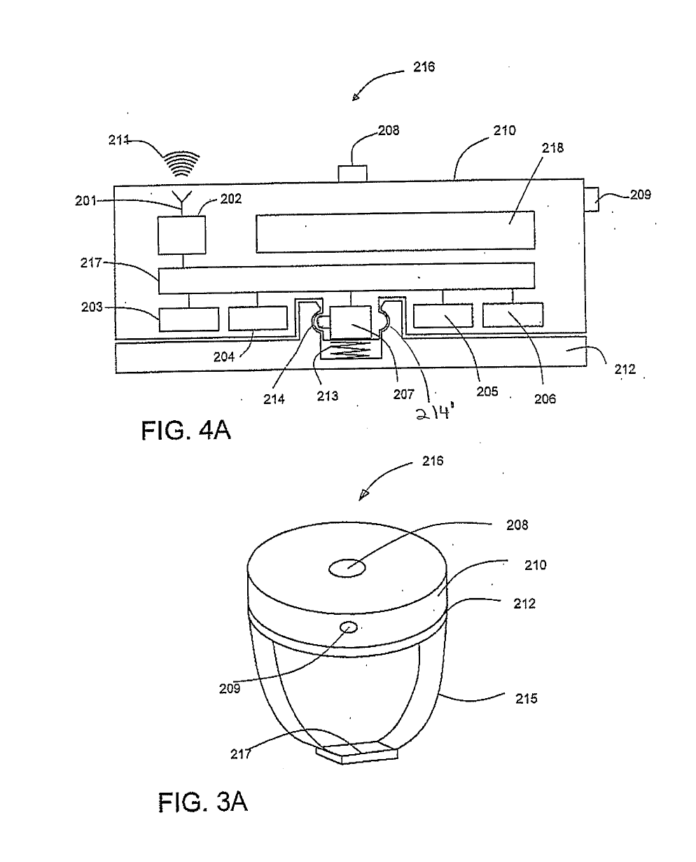

FIG. 3A shows the alarm device 216, in accordance with a first preferred embodiment of the present invention. Herein after alarm device 216 will be referred to as the TFA (Transmitter/Float Attachment) device 216. In the first preferred embodiment of the invention the TFA device 216 includes a float unit 210, and an attachment unit 212. Attachment unit 212 is used to carry mechanical components the function thereof is to fasten or otherwise attach TFA device 216 to the body of a subject, such as subject 14 of FIG. 1. In some preferred embodiments of the invention attachment unit 212 carries a regular wristband 215 having two segments that are connected one to other via a buckle 217. Thus, externally TFA device 216 has the general appearance of a water-proof wristwatch wearable on the wrist of a subject, such as subject 14 of FIG. 1. In other preferred embodiments of the invention TFA device 216 could be built, such as to be integral part of an actual water-proof wristwatch adapted specifically to hold the additional components comprising the TFA device 216. In still other preferred embodiments TFA device 216 could have different forms, structures, components, inter-connections, and internal arrangements of components. For example, specifically adapted headband, different types of sensors, and one or more batteries could be used, and like. In other preferred embodiments TFA device 216 could be attached conveniently to the swimming suit of a subject, such as subject 14 of FIG. 1 or to different parts of the body of a subject, such as subject 14 of FIG. 1, such as the fingers, forehead, upper arms, ankles, back, chest, and the like. In the first preferred embodiment of the invention float unit 210 is located in the upper part of TFA device 216 and is attached releasably to the attachment unit 212 located below. Float unit 210 includes a gas-filled space that provides for positive buoyancy. The gas may include, for example air, nitrogen, helium or any combination thereof. Float unit 210 is connected releasably to attachment unit 212 which is located in the lower part of TFA device 216. The function of float unit 210 is the early detection of a is drowning or a near-drowning situation of a subject, such as subject 14 of FIG. 1 and consequently the initiation of the transmission of alarm signals or warning signals directly or indirectly to a potential rescuer. TFA device 216 further includes a light source 208, such as a Light Emitting Diode (LED) for optional visual signaling and a push-button 209 for battery check, components check, and/or for emergency manual release of float unit 210 from TFA device 216. A more detailed description of the functionality, structure, inter-connections and interactions between the units constituting TFA device 216 will be provided herein after in conjunction with the following drawings.

FIG. 3B shows the pool alarm device 16, in accordance with the second preferred embodiment of the present invention. In the second preferred embodiment of the invention the TFA device 16 includes a float unit 24, a base unit 28, and an attachment unit 32. Attachment unit 32 is used to carry mechanical components the function thereof is to fasten or otherwise attach TFA device 16 to the body of subject 14 of FIG. 1. In some preferred embodiments of the invention attachment unit 32 carries a regular wristband 30 having two segments that are connected one to other via a buckle 34. Thus, externally TFA device 16 has the general appearance of a water-proof wristwatch wearable on the wrist of subject 14 of FIG. 1. In other preferred embodiments of the invention TFA device 16 could be built, such as to be integral part of an actual water-proof wristwatch adapted specifically to hold the additional components comprising the TFA device 16. In still other preferred embodiments TFA device 16 could have different forms, structures, components, inter-connections, internal arrangement of components, specifically adapted headband, different types of sensors, one or more batteries, wired connection between float unit 24 and base unit 28, and like. In other preferred embodiments TFA device 16 could be attached conveniently to the swimming suit of subject 14 or to different parts of the body of subject 14 of FIG. 1, such as the fingers, forehead, upper arms, ankles, back, chest, and the like. In the second preferred embodiment of the invention float unit 24 is located in the upper part of TFA device 16 and is attached releasably to the base unit 28 located below it. Float unit 24 includes a gas-filled space that provides for positive buoyancy. The gas may include, for example air, nitrogen, helium or any combination thereof. Base unit 28 is connected permanently to attachment unit 32 which is located in the lower part of TFA device 16. The function of base unit 28 is the early detection of a drowning or a near-drowning situation of a subject such as subject 14 of FIG. 1 and consequently the initiation of the transmission of alarm signals or warning signals to a potential rescuer via the float unit 24. A more detailed description of the functionality, structure, inter-connections and interactions between the units constituting TFA device 16 will be provided herein after in conjunction with the following drawings.

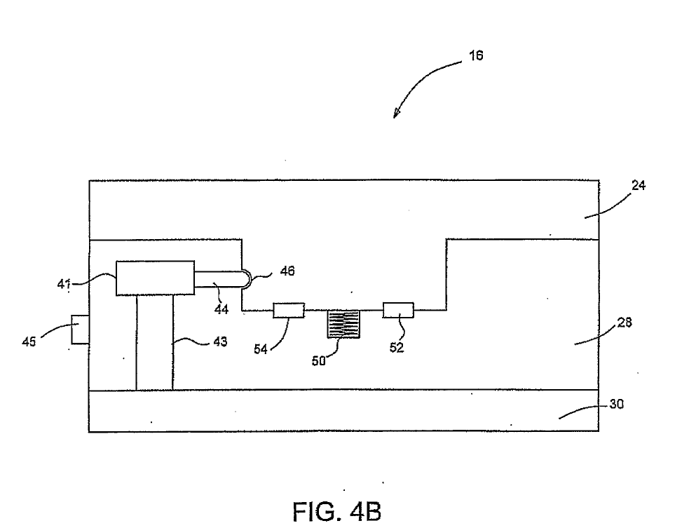

Referring now to FIG. 4A which is a block diagram showing the structure of the TFA device 216, and the inter-connections among the constituting units and the principal components of the float unit 210. TFA unit 216 includes a float unit 210, and an attachment unit 212. Float unit 210 includes an internal antenna 201, a radio frequency transmitter 202, a battery 203, a microcontroller 204, a movement sensor 205, a water sensor 206, an electro mechanical apparatus (EMA) 207, a LED 208, a push-button 209, a loaded spring 213, a buoyancy apparatus 218, a printed circuit 217, elastic sockets 214 and 214′ and optionally a Global Positioning System (GPS) receiver device (not shown). Float unit 210 is attached releasably to attachment unit 212. The elastic socket 214 may be adapted to facilitate the release of float unit 210. The sensors 205 and 206 are utilized to measure, for example continuously, external one or more environmental parameter(s) values, such as the type of the surrounding media (air or water) movement indication parameters, such as body vibrations and the like. The values sensed and measured by the sensors 205 and 206 are fed into a microcontroller 204 for suitable processing, transformation, switching and/or storage. Microcontroller 204 receives the values provided by sensors 205 and 206 and determines according to a specific logical processing, associated calculation executed by a specific set of computing instructions and according to the values provided by sensors 205 and 206 whether a subject, such as subject 14 of FIG. 1 wearing TFA device 216 is in a regular swimming situation or in a drowning or near-drowning situation. Based on the results of the processing if a drowning or near-drowning situation is indicated then the microcontroller 204 activates the appropriate internal components of float unit 210, such as transmitter 202 in order to begin the transmission of the alarm signals and EMA 207 in order to release the float unit 210 from the attachment unit 212. As a result of the positive buoyancy of float unit 210 and the pushing force of the loaded spring 213 the float unit 210 moves upward and away form the attachment unit 212. Note should be taken that an externally-mounted manually-operated push-button 209 is attached to float unit 210 The pressing of push-button 209 will produce a signal in accordance with the status of the water sensor 206 and the length of the period of the pressing. When the water sensor 206 indicates that TFA device 216 is out of water then a long period pressing will affect a thorough test of the operation of the TFA device 216 and the testing of the battery 203. When the water sensor 206 indicates that the TFA device 216 is under water then a short period pressing will have no effect while a long period pressing will release the float unit 210 from the attachment unit 212 by activating directly transmitter 202 in order to begin transmitting and EMA 207 in order to release float unit 210 independently of the data supplied by movement sensor 205 and the results of the situation-determination calculations. In some preferred embodiments of the invention, water sensor 206 may include two metal plates where the space there between is exposed to water. When water fills the inter-plate space a circuit is closed and the controller receives signal indicating “wet” environment. In other preferred embodiments other water sensor means could be used, such as hydrostatic or hydrodynamic pressure gauges, conductance meters, or any other electrical or mechanical water sensor means. Global Positioning System receiver device (not shown) provides the option of precisely determining the location of the subject in a drowning or near-drowning situation.

Referring now to FIG. 4B which is a block diagram showing the structure of the TFA device 16 and the inter-connections among the constituting units, in accordance with the second preferred embodiment of the present invention. TFA unit 16 includes a float unit 24, a base unit 28 and an attachment unit 30. Base unit 28 includes sensors 43, a microprocessor 41, an electro mechanical apparatus (EMA) 44, a micro-switch 52, a loaded spring 50, a push-button 45, and an electrical plug 54 accommodating an automatically disconnectable plug. Sensors 43 that are utilized to measure, for example continuously, external one or more environmental parameter(s) values, such as the type of the surrounding media (for example, air or water) and water depth, body movement indication parameters, such as acceleration and swimming speed, body attitude parameter values, such as a position in the vertical/horizontal axes, and the like or any combination thereof. The values sensed and measured by the sensors 43 are fed into a microprocessor 41 for suitable processing, transformation and/or storage. Microprocessor 41 receives the values provided by sensors 43 and determines according to a specific logical processing and associated calculation executed by a specific set of computing instructions and according to the values provided by sensors 43 whether a subject, such as subject 14 of FIG. 1 wearing TFA device 16 is in a regular swimming situation or in a drowning or near-drowning situation. Based on the results of the processing if a drowning or near-drowning situation is indicated then the microprocessor 41 activates the EMA 44. EMA 44 releases float unit 24 from base unit 28 via elastic socket 46. As a result of the positive buoyancy of float unit 24 the unit 24 moves upward and away form the base unit 28. Loaded spring 50 pushes against the EMA 44 and assists in the release float unit 24 from TFA unit 16 and accelerates the upward movement of the float unit 24. Substantially simultaneously, with the separation of float unit 24 from base unit 28 the appropriate internal components of float unit 24 are activated in order to begin the transmission of alarm signals. Push-button 45 is externally mounted on TFA device 16. Push-button 45 may be operative in the activation of the elements of TFA device 16 and in the consequent performance of a comprehensive test of suitable tests designed to check the operability of TFA device 16. Push-button 45 may further be operative in the testing of the battery (not shown) and in the manual emergency release of the float unit 24 from the base unit 28 where required. The operational options for the activation of push-button 45 may be identical to the options associated with push-button 209 of FIG. 4A.

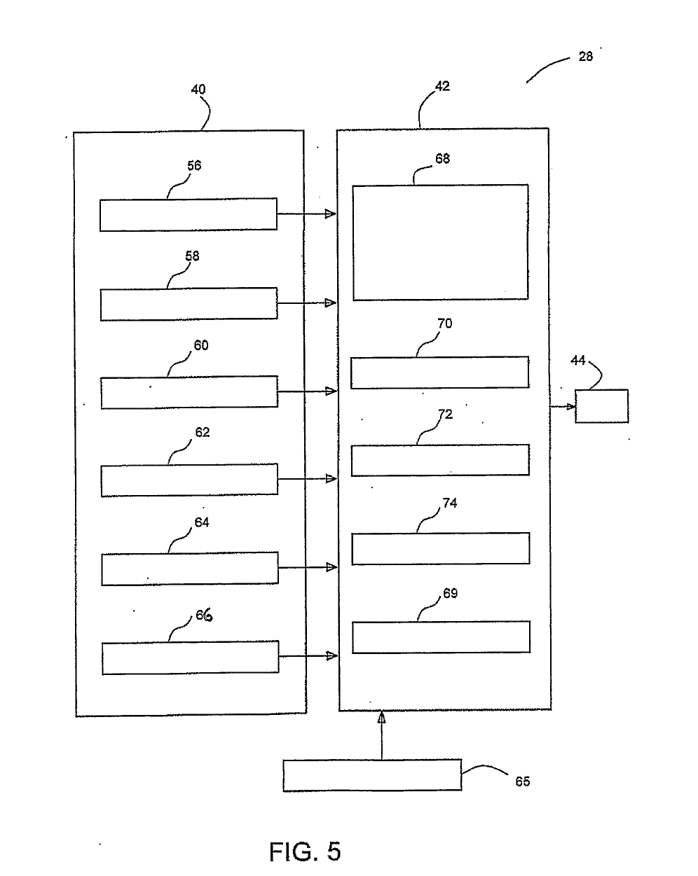

Referring now to FIG. 5 which is a block diagram showing selected components of the base unit 28 of TFA device 16 of FIG. 1, in accordance with the second preferred embodiment of the present invention. Sensor housing 40 contains several sensors. In different preferred embodiments different sets of sensors are used. The drawing under discussion includes several sensors that could be used across various embodiments. Thus, housing 40 includes for example, a water sensor 56, a movement sensor 58, a hydrostatic and/or hydrodynamic pressure sensor 60, an inclination sensor 62, and/or various other optionally installed sensors, generally referenced as sensors 64 and 66. More sensors within the housing 40 are also possible. In a preferred embodiment of the invention the water sensor 56 and the movement sensor 58 may be used exclusively. Data produced by water sensor 56 indicates whether the TFA unit 16 of FIG. 1 and/or the attached base unit 28 and therefore the body part of the subject, such as subject 14 of FIG. 1 that is attached to TFA unit 16 of FIG. 1 is immersed in water. Generally, water sensor 56 indicates that the subject, such as subject 14 of FIG. 1 is submerged in the water. Movement sensor 58 is preferably a vibration sensor. Movement sensor 58 could also be an accelerometer that measures the acceleration of the subject, such as subject 14 of FIG. 1 during swimming and thereby indicates whether the subject 14 of FIG. 1 is in movement or at rest. Water sensor 56 has three main objectives: a) to activate base unit 28 consequent to the entry of the subject, such as subject 14 of FIG. 1 to the water, b) to deactivate base unit 28 after subject 14 of FIG. 1 exits the water, and c) to indicate continuously whether subject 14 of FIG. 1 is in the water or out of it. Movement sensor 58 continuously provides information concerning the movements of subject 14 of FIG. 1. The information provided by the water sensor 56 and the movement sensor 58 indicates in combination the situation of subject 14 of FIG. 1. For example, if water sensor 56 indicates “wet environment” and sensor 58 indicates a specific acceleration measurement value which is below a pre-defined threshold value then it could be assumed that subject 14 of FIG. 1 is in drowning or near-drowning situation. In contrast, if water sensor 56 indicates “wet environment” and sensor 58 indicates a specific acceleration measurement value which is above a pre-defined threshold value then it could be assumed that subject 14 of FIG. 1 is in a regular swimming situation.

In other preferred embodiment other sensors could be used to refine the calculation, to improve the accuracy of the results and to prevent potential false alarms. Thus, hydrostatic and/or hydrodynamic pressure sensor 60 could indicate the movements of subject 14 of FIG. 1. For example, if water sensor 56 indicates “wet” environment, sensor 58 indicates a specific acceleration measurement value which is above a pre-defined threshold value but hydrostatic and/or hydrodynamic pressure sensor 60 indicates movements of subject 14 of FIG. 1 then it could be assumed that subject 14 of FIG. 1 is struggling underwater without advancing and therefore a potential drowning or near drowning situation is developing.

Still referring to FIG. 5 microcontroller 42 includes a memory 68, a control circuitry 70, a processing means 72, an analog-to-digital (A/D) converter 69, and threshold values 74. Microcontroller 42 is a computing device capable of receiving data, of storing data, of processing data, of transforming data and to output data in accordance with results of the processing. A/D converter 69 is adapted to receive analog information from one or more sensors 56, 58, 60, 62, 64, 66 and to convert the analog signals to digital signals The digital information is stored in memory 68, and processed by processing means 72 that may include, for example, software programs, hardware instructions and the like, by traditional hardware logic component(s) such as control circuitry 70 that may include, for example, registers, accumulators, logic gates, data buses, timers, comparators and the like. The programs utilize control tables, threshold values 74 and the like, during the execution of their own internal logical instructions. The logic instructions produce specific results that in accordance with their truth values could be transformed into control signals and sent through the control circuitry 70 to activate electro-mechanical components, such as EMA 44. The microcontroller 42 is powered by battery 65. In a preferred embodiment of the invention, battery 65, which may providing a voltage of 3V may be installed in float unit 24 of FIG. 3B and power base unit 28 via automatically disconnectable electrical plug 54 of FIG. 4B located between float unit 24 and base unit 28 of FIG. 3B. In other preferred embodiments of the invention both float unit 24 and base unit 28 of FIG. 3B are equipped and powered by separate independently operating batteries. Still in other preferred embodiments battery 65 is installed in base unit 28 and powers float unit 24 of FIG. 3B consequent to the release thereof via an extensible wire line (not shown) that gradually unrolls from a specific roll housing (not shown) during the rise of float unit 24 of FIG. 3B to surface 18 of FIG. 1. Thus, the wire line (not shown) connects electrically base unit 28 to float unit 24 of FIG. 3B at all times. Note should be taken that the above arrangement is unsuitable to large swimming pools or crowded bathing areas where literally hundreds of subjects could be in the water at the same time. Note should be taken that in other preferred embodiments of the invention microcontroller 42 could be replaced by other controller means such as a switching unit in order to indicate specific situations associated with the subject 14 of FIG. 1 in accordance with the switching states of the switching unit.

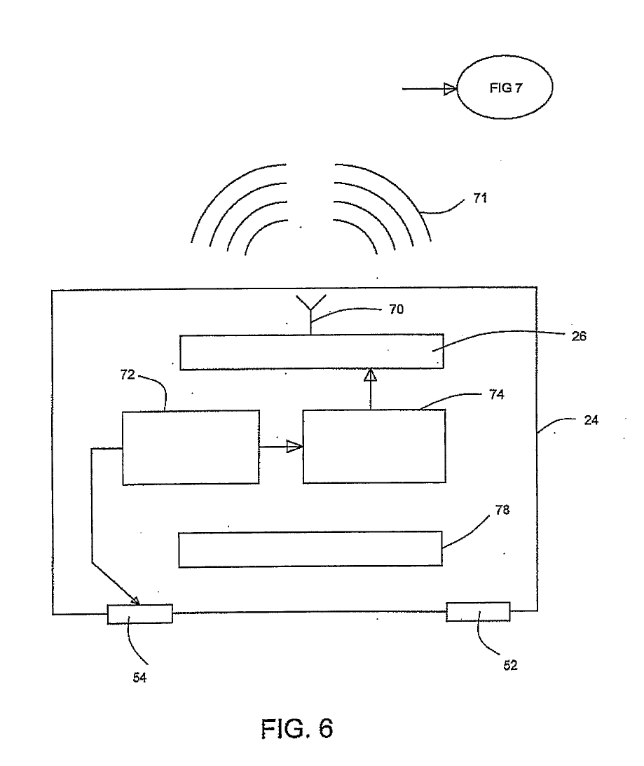

Referring now to FIG. 6 which is a block diagram showing functional components of the float unit 24 of the TFA device 16 of FIG. 1, in accordance with the second preferred embodiment of the present invention. Float unit 24 includes an internal antenna 70 coupled to a transmitter 26 (such as radio frequency transmitter), a switch 74 activated by a micro-switch 52, a battery 72 controlled by switch 74 and an air-filled or other suitable gas-filled buoyancy canister 78 to provide for positive buoyancy. When the float unit 24 is released from the base unit 28 of FIG. 3B the micro-switch 52 is activated and consequently sets switch 74 on. Switch 74 connects battery 72 to transmitter 26 in order to activate transmitter 26. With the activation transmitter 26 starts to output pre-defined and pre-set alarm signals 71, such as RF modulated signals and/or US signals and attempts to transmit the signals 71 via internal antenna 26. As long as float unit 24 is submerged in the water 12 of FIG. 1 RF modulated signals 71 are blocked by the surrounding medium. US signals, on the other hand pass through medium such as water and air. When float unit 24 surfaces the transmission of the signals 71 becomes effective (in the case of RF modulated signals) and the signals 71 propagate from the internal antenna 70 towards the poolside area within a pre-defined reception zone. In a preferred embodiment of the invention, prior to the release of float unit 24 from base until 28 of FIG. 3B battery 72 is operative and supplies power to base unit 28 of FIG. 3B via electrical plug 54. In other preferred embodiments of the invention, battery 72 powers only float unit 24 while yet other preferred embodiments no battery is installed in float unit 24. In such a case, a battery similar to battery 72 is installed in base unit 28 of FIG. 3B and supplies power to base unit 28 of FIG. 3B until the release of float unit 24 and supplies power to float unit 24 after the release float unit 24 from base unit 28 of FIG. 3B via extensible wire line connecting base unit 28 of FIG. 3B with float unit 24.

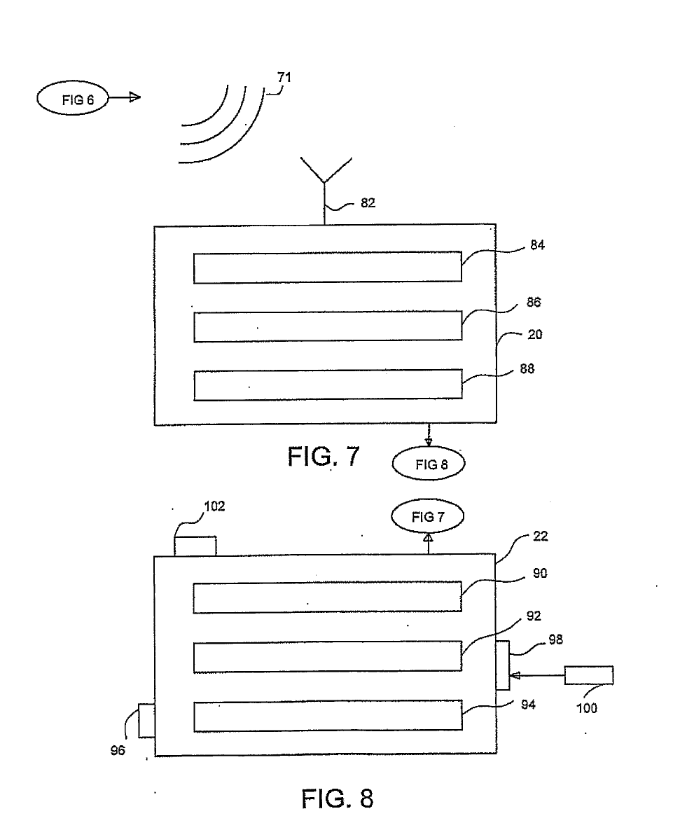

Referring now to FIG. 7 which is a block diagram showing functional components of the receiver unit 20 of the pool alarm apparatus, in accordance with some preferred embodiments of the invention. Receiver 20 could be substantially miniaturized, such that it could be integrated into a wristwatch attached to a lifeguard's wrist. Receiver 20 could also be installed in a small-sized unit placed on the poolside or in the reception area of the signal near the body of water. Receiver 20 includes an external antenna 82, a radio frequency receiver 84, such as a radio frequency sonic and/or ultrasonic receiver, a signal detector 86 and an alarm generator 88. Antenna 82 is coupled to receiver 84. Antenna 82 receives signals 71 from antenna 70 of float unit 24 of FIG. 6 and feeds the signals 71 to receiver 84. Signal detector 86 detects the signals and where the signals are identified as signals 71 alarm signal generator 88 is activated. Alarm signal generator 88 produces specific alarm indicator signals and transmits the indicator signals in either a wired or a wireless fashion to supervisory workstation 22 of FIG. 1. Note should be taken the in other preferred embodiments of the invention, some or all of the components included in receiver unit 20 could be incorporated into supervisory workstation 22 of FIG. 1. In some of the embodiments, receiver 20 could be dispensed with the functionality thereof being performed by the supervisory workstation 22 of FIG. 1. In still other preferred embodiments of the present invention, specifically when the pool alarm apparatus is installed in a large public swimming pool or other large bathing area, a plurality of receiver units, such as receiver 20, could be located in the signal reception area around the periphery of the pool 10 of FIG. 1, where each of receivers being connected to a common supervisory workstation 22 of FIG. 1.

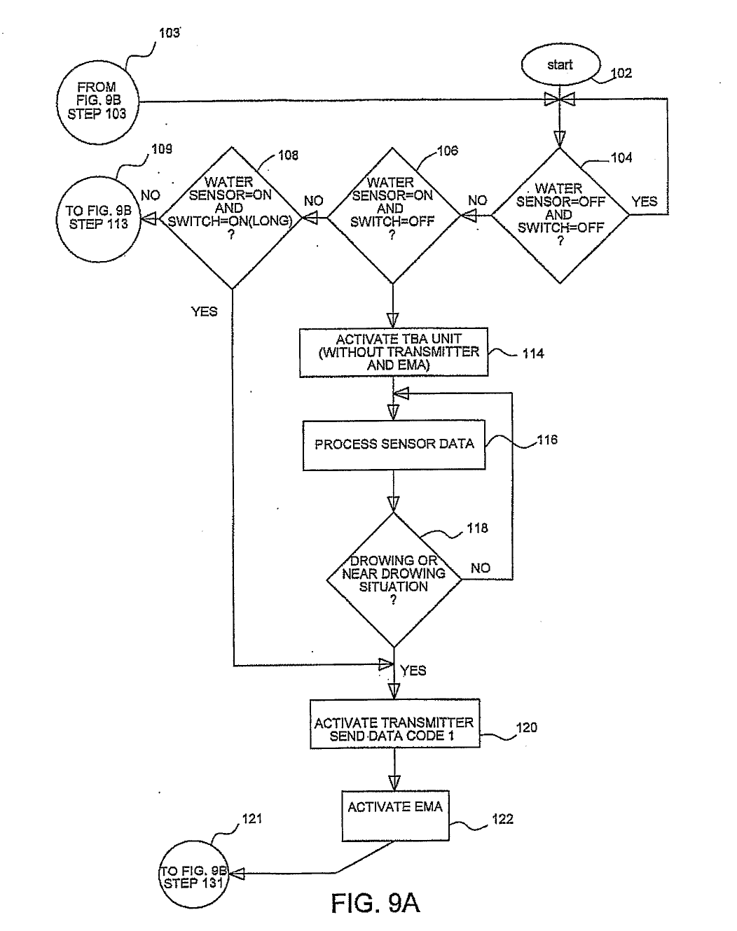

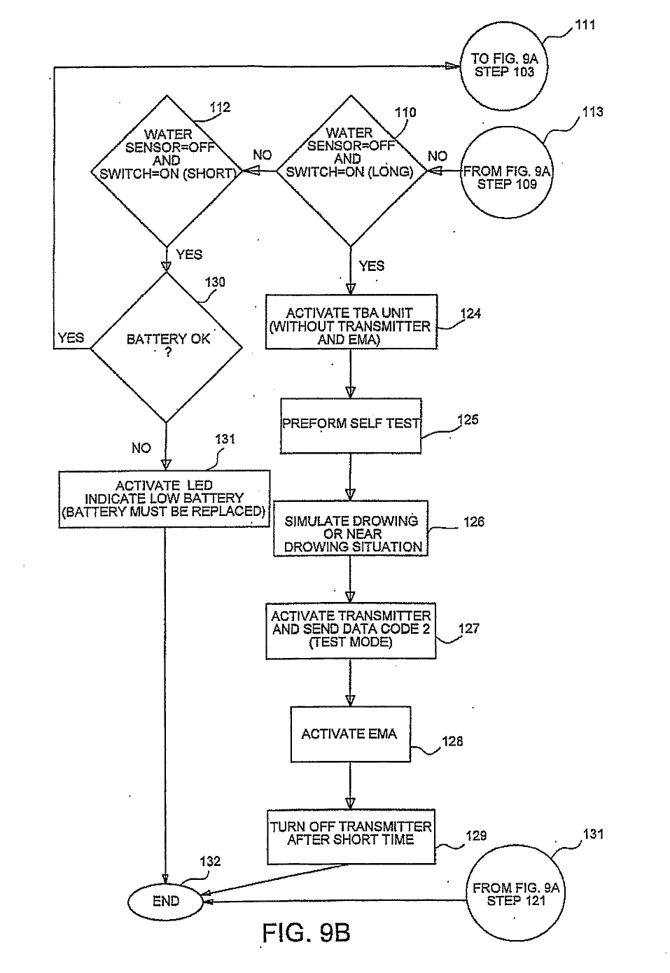

FIG. 8 is a block diagram showing the functional components of the supervisory workstation 22 of the pool alarm apparatus, in accordance with some preferred embodiments of the present invention. Workstation 22 includes a video display screen 90 and/or an audio alarm generator or synthesizer 92, a control circuit 94, a speaker 96, a light source 102, such as a Light Emitting Diode (LED), and an electrical socket 98. Alarm indicator signals from receiver 20 of FIG. 1 are sent to the control circuitry of workstation 22. Through the control circuitry the signals are sent to audio alarm generator or synthesizer 92, to display screen 90 and to light source 102. Generator or synthesizer 92 generates an audio alarm and the audio alarm is outputted via speaker 96, optionally activate a siren, a horn or a hooter or optionally sent via standard communication channels to a remote device, such as a cellular phone in order to effectively alert a lifeguard, a supervisor, or any other subject to the drowning or near-drowning situation of subject 14 of FIG. 1. Optionally, the alarm indicator signal could command the acquisition and display of a specific video image on display 90. Optionally, the alarm indicator signal effects the switching of the light source 102 in a continuous or intermittent manner, such that the light source is either a light signal continuously or intermittently to create a light blinking effect in order to draw the attention of the lifeguard or of other supervisory subject. Consequent to the effective recognition of the situation by the audio signaling and optionally by the video signaling and the light signaling, the potential rescuer, such as a lifeguard, initiates life saving procedures, such as carrying subject 14 of FIG. 1 to the surface 18 of FIG. 1 of the pool 10 of FIG. 1, removing subject 14 of FIG. 1 from the pool 10 of FIG. 1 to the poolside area and if required beginning emergency medical procedures on subject 14 of FIG. 1. In other preferred embodiments of tche invention, some or all of the components included in the supervisory workstation 22 could be incorporated into receiver 20 of FIG. 1. In some of the embodiments, workstation 22 could be dispensed with the functionality thereof being performed by the receiver 20 of FIG. 1.

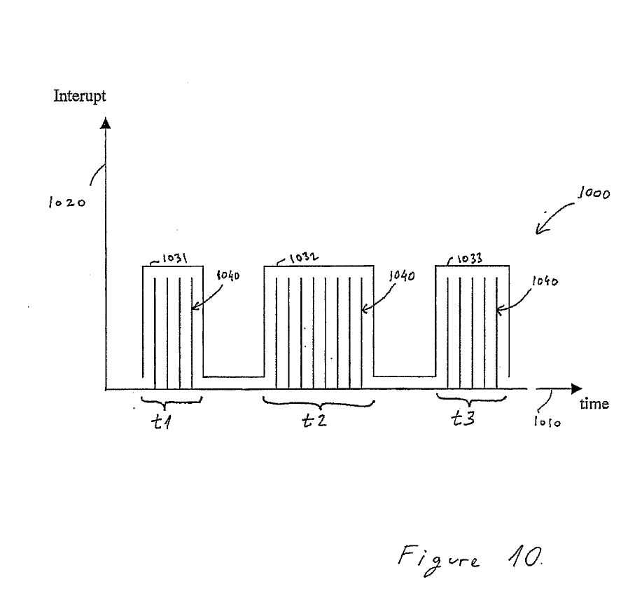

Referring now to FIGS. 9A-9B which are flowcharts describing the logic of the operation of the pool alarm device, in accordance with the first preferred embodiments of the present invention. It would be easily understood that in other preferred embodiments the logic of the operation could be different. The operation of the pool alarm device 216 of FIG. 3A begins at step 102 of FIG. 9A. The logical path of the execution is based in combination on the status of the water sensor 206 of FIG. 4A and on the state of push-button 209 of FIG. 4A. At determination step 104 it is determined whether status of the water sensor 206 of FIG. 4A is OFF and the state of the push-button 209 of FIG. 4A is OFF. Positive result of determination step 104 indicates that the pool alarm device 216 of FIG. 4A is not in a “wet” environment, such as being out of the body of water and no device components check or battery check is being performed. Consequently, program logic returns to determination step 104 in order to perform a loop thereon until the result of step 104 is negative. Negative result of step 104 indicates that the status of water sensor 206 of FIG. 4A is ON and/or the state push-button 209 of FIG. 4A is ON. At determination step 106 it is determined whether the status of water sensor 206 of FIG. 4A is ON and the state of push-button 209 of FIG. 4A is OFF. Positive result of step 104 indicates that pool device 216 of FIG. 4A is submerged in water while push-button 209 of FIG. 4A is not pressed. Consequently, at action step 114 all the operative components of TFA unit 216 of FIG. 4A (except transmitter 202 and EMA 207) are enabled for action. As a result, the sensors 205 and 206 of FIG. 4A begin feeding sensor data to the microcontroller 204 of FIG. 4A. At action step 116 the microcontroller 204 of FIG. 4A begins to process sensor data. At determination step 118 it is determined whether the subject 14 of FIG. 1 is in a drowning or a near-drowning situation. If the result of determination step 118 is negative then logic control returns to step 116 in order to execute a loop across steps 116-118 until the result of determination step 118 is positive. Positive result of step 118 indicates that subject 14 of FIG. 1 is in a drowning or near-drowning situation. Consequently, at action step 120 transmitter 202 of FIG. 4A is activated and a pre-defined data code indicating alarm is transmitted by the transmitter 202 of FIG. 4A. In some preferred embodiments of the invention, the value 1 is used as alarm code although it could be easily perceived that in other preferred embodiments other values could be used. At action step 122 EMA 207 is activated in order to release the float unit 210 from the attachment unit 212 and logic control proceeds to termination step 132 of FIG. 9B via figure connector indicator 121 of FIG. 9A and via figure connector indicator 131 of FIG. 9B.

Still referring to FIGS. 9A-9B, if the result of determination step 106 is negative then at determination step 108 is determined whether the status of water sensor 206 of FIG. 4A is ON and the push-button 209 of FIG. 4A was activated by a long period pressured. Positive result indicates that pool alarm device 216 of FIG. 4A is submerged in the body of the water and the release of float unit 210 of FIG. 4A was initiated in a manual manner. Thus, logic control proceeds to action step 120 whereat transmitter 202 of FIG. 4A is activated and the pre-defined data code 1 indicating alarm is transmitted by the transmitter. Next, at action step 122 EMA 207 of FIG. 4A is activated in order to release the float unit 210 of FIG. 4A from the attachment unit 212 of FIG. 4A. If the result of determination step 108 is negative then logic control proceeds to determination step 110 of FIG. 9B via figure connector indicator 109 and figure connector indicator 113 of FIG. 9B. At determination step 110 of FIG. 9B it is determined whether the status of water sensor 206 of FIG. 4A is OFF and push-button 209 of FIG. 4A was pressed for a long period. Positive result of determination step 108 indicates that pool alarm device 216 of FIG. 4A is out of the body of water and a comprehensive test of the device 216 of FIG. 4A was initiated. Thus, at action step 124 all the operative components of TFA device 216 of FIG. 4A are enabled (except transmitter 202 and EMA 207), at action step 125 self-test is performed on TFA device 216 of FIG. 4A, at action step 126 a drowning or near-drowning situation indication is simulated by TFA device 216 of FIG. 4A, at action step 127 transmitter 202 of FIG. 4A is activated and a pre-defined alarm code having the value of 2 is transmitted, at action step 128 EMA 207 of FIG. 4A is activated and finally at action step 129, transmitter 202 of FIG. 4A is turned off after a pre-defined length of period. Next, the operation is terminated at termination step 132.

Still referring to FIGS. 9A-9B if the result of determination step 110 is negative then at determination step 112 it is determined whether the status of water sensor 206 of FIG. 4A is OFF and the state of push-button 209 of FIG. 4A was pressed for a short period. Positive result of determination step 112 indicates that pool alarm device 216 of FIG. 4A is out of water and a battery test was initiated. Following positive result of determination step 112 at determination step 130 the battery 203 of FIG. 4A is checked and it is determined whether the status of the battery 203 of FIG. 4A is sufficient for standard operations of TFA unit 216 of FIG. 4A. If the result is negative then at action step 131 LED 208 of FIG. 4A is activated in order to indicate the low battery status and the necessity to replace battery 203 of FIG. 4A. In contrast, if the result of determination step 130 is positive then logic control proceeds to step 104 of FIG. 9A via figure connector indicator 111 and figure connector indicator 103 of FIG. 9A in order to repeat the logical path of execution.

The above mentioned sensors could include an additional voluntary-muscle-movement sensor. When a subject moves the arms or the legs in the water the muscles of the arms or the legs, specifically the Biceps muscles are activated in a specific manner. In order to detect voluntary movements of the muscles involved a specific muscle-movement sensor, such as a strain-gauge, could be attached superficially to the above mentioned muscles as it is used in the detection of uterine contraction. The activity of the strain-gauge sensor is based on specific known physical and electrical phenomena that enable detecting voluntary movements of the muscles. Prolonged lack of voluntary movement in the muscles when the subject is underwater could clearly indicate a drowning or near-drowning situation. The advantage in the utilization of the proposed muscle-movement-sensor regards non-dependency on the surrounding environment as expressed through natural factors such as waves, currents, drift, and the like. The utilization of this method enables to differentiate voluntary arms or legs movements from passive arms or legs movements.

Some embodiments of the invention may include and/or utilize, for example, a device, system and/or method to compensate for or to disregard environmental noise or disturbance; to identify and/or to take into account non-drowning movements or non-near-drowning movements; to identify and/or to take into account movements of a body of water (e.g., a wave, a water current, high tide, low tide, or the like); to differentiate between an active movement of a non-drowning subject (e.g., swimming or actively floating) and a passive movement of a drowning or near-drowning subject (e.g., sinking, or moved by a wave or a current or tide); or to calibrate and/or fine-tune a drowning-detection mechanism or a near-drowning detection mechanism (e.g., calibrated relative to waves or currents).

In some embodiments, a compensation/calibration mechanism may be included or, or may operate in conjunction, for example, with one or more of the alarm devices and/or components described with reference to FIGS. 1-9, with movement sensor 58 of FIG. 5, and/or with other suitable components, devices or systems. Although portions of the discussion herein may relate, for demonstrative purposes, to a compensation/calibration mechanism embedded within movement sensor 58 of FIG. 5, embodiments of the invention are note limited in this respect, and may be utilized within or in conjunction with other suitable components, devices and/or systems.

In some embodiments, for example, movement sensor 58 may identify and/or determine that a subject (e.g., a human) is substantially inactive, drowning or near-drowning inside a body of water (e.g., a lake, a sea, a swimming pool, or the like), even if the subject may be moved (e.g., randomly, pseudo-randomly, repeatedly, sporadically, in accordance with a wave pattern, or the like) by the body of water (e.g., by a wave, a current, a high tide, a low tide, a sporadic movement of another object or another subject in the body of water, or the like).

In some embodiments, movement sensor 58 may count or measure a period of time in which no movement is identified, and may generate or trigger an alarm signal if the elapsed non-movement period is greater than a pre-defined threshold value. For example, the movement sensor 58 may be pre-programmed to measure whether the subject is substantially not moving for at least N consecutive seconds, and to trigger an alarm signal if the subject is substantially not moving for at least N consecutive seconds. The number of seconds may be pre-programmed, for example, to 10 seconds, 20 seconds, 24 seconds, or other suitable values, optionally by taking into account the age and/or swimming experience of the subject.

In some embodiments, the movement sensor 58 may reset the non-movement period upon detection of a movement, or optionally when a pre-defined condition is met, for example, if active movement is determined (in contrast with passive movements) or if a movement commencement is determined. Optionally, the movement sensor 58 may be pre-programmed to disregard sporadic movements or passive movements (e.g., due to waves or currents) and to take into account only active movements or human movements or actual movement commencements attributed to the subject. The movement sensor 58 may, for example, utilize a movement commencement parameter which may correspond to the first movement in a series or a set of movements. The movement sensor 58 may, for example, identify a commencement of a first set of movements, associating the set of movements with a pre-defined time period, optionally resetting or offsetting a timer or counter, and identifying commencement of a second series or sets of movements.

In some embodiments, for example, the movement sensor 58 may take into account that an active (e.g., non-drowning and/or non-near-drowning) subject may perform a relatively high number of movement actions within a pre-defined time period. For example, in some embodiments, a subject may perform approximately 10 movement operations within a 30-seconds time period; other suitable values may be used, for example, based on experimentation results, based on statistical data, based on specific subjects or swimming expertise, based on ages or age groups, or the like.

In contrast, in some embodiments, a passive subject (e.g., a drowning and/or near-drowning subject) may perform substantially no movement operations (e.g., zero movement commencement operations) within a pre-defined time period. For example, in some embodiments a drowning subject may perform zero movement operations within a 30-seconds time period. Alternatively, in some embodiments, a passive subject may be passively moved (e.g., by waves or currents) for a relatively small number of movements, thereby causing a relatively small number of interrupts within a pre-defined time period to a counter of the movement sensor 58. Accordingly, in some embodiments, the movement sensor 58 may differentiate or distinguish between an active (e.g., non-drowning and/or non-near-drowning) subject and a passive (e.g., drowning and/or near-drowning) subject by taking into account the number of movement operations associated with one or more time periods.

In some embodiments, for example, the movement sensor 58 may be programmed to determine and/or count the number of movements that are identified within a time period of N consecutive seconds. For example, the movement sensor 58 may determine and/or count a number of movements or interrupts, denoted C, within a first time period of N consecutive seconds. In some embodiments, during subsequent time periods of N consecutive seconds (e.g., during a second time period of N consecutive seconds, during a third time period of N consecutive seconds, or the like), the movement sensor 58 may require an increased number of movements or interrupts in order to reset the movement commencement parameter, or in order to determine that an active movement is attributed to the subject (in contrast with a passive movement attributed to waves or currents). For example, an increased number of movements or interrupts may be utilized and denoted kC, wherein k may be a positive number greater than one; for example, k may be equal to 1.7, to 2, to 2.4, or the like.

In some embodiments, for example, the movement sensor 58 may determine that the subject is drowning and/or near-drowning, if C movements or interrupts are identified within a first pre-defined time period N, but less than kC movements or interrupts are identified within a second (or other subsequent) pre-defined time period N. In some embodiments, for example, the value of k may be pre-programmed or may be dynamically adjusted (e.g., optionally in real time).

In some embodiments, optionally, the sensitivity of movement sensor 58 may be reduced or decreased in relation to the time period that elapses since commencement of movement in the body of water. For example, the movement sensor 58 may be programmed to identify patterns or waves in the body of water and to disregard passive movements of the subject due to such waves. In other embodiments, in contrast, the sensitivity of movement sensor 58 may be increased in relation to the time period that elapses since commencement of movement in the body of water. For example, the movement sensor 58 may be programmed to take into account possible fatigue of the subject, which may occur after a relatively long period within the body of water. Other suitable parameters or calculations may be used to take into account, or to compensate for, various events which may result in a false resetting of a movement counter or a false resetting of a movement counter.

FIG. 10 is a schematic illustration of a graph 1000 of movements of a subject in a body of water as a function of time in accordance with some demonstrative embodiments of the invention. A horizontal axis 1010 may correspond, for example, to time. A vertical axis 1020 may correspond, for example, to interrupts, to movements, or to movement commencements.

As indicated in FIG. 10, multiple movements 1031, 1032 and 1033 of the subject in the body of water may be identified. Each of movements 1031, 1032 and 1033 may include one or more interrupts 1040 of the movement sensor 58 corresponding to a motion of the subject. For example, a first movement 1031 may correspond to four interrupts 1040 and to a duration of a first time period, denoted t1; a second movement 1032 may correspond to eight interrupts 1040 and to a duration of a second time period, denoted t2; and a third movement 1033 may correspond to five interrupts 1040 and to a duration of a third time period, denoted t3.

In some embodiments, movement sensor 58 may distinguish and/or differentiate among movements 1031, 1032 and 1033 even though each movements may include a different number of interrupts 1040. For example, a sequence, a set, a subset or a series of interrupts 1040 identified by movement sensor 58 may be determined to indicate a single movement and/or a movement commencement. For example, a set of consecutive interrupts 1040 separated in time from other one or more interrupts 1040 may be determined to indicate a single movements and/or a movement commencement.

In some embodiments, a movement commencement parameter and/or condition may be utilized. For example, a movement commencement condition may require that the movement sensor identifies a minimum number of interrupts 1040 within a time period in order to determine movement commencement. Optionally, in some embodiment, the movement commencement parameter or condition may be utilized subsequent to a relatively long period of time in which the subject is substantially passive, non-active, idle, or non-moving. In some embodiments, optionally, the movement commencement condition may be utilized by movement sensor 58 as a condition to resetting a counter or timer of movement sensor 58. Other suitable calculations may utilized the movement commencement parameter or condition.

It will be appreciated by persons skilled in the art that the present invention is not limited to what has been particularly shown and described hereinabove. Rather the scope of the present invention is defined only by the claims which follow.

1-63. (canceled)

64. A wearable apparatus for the detection of a subject in a drowning or near-drowning situation, the apparatus comprising: a detection unit adapted to detect at least one body movement related parameter and at least one environmental parameter; and a controller adapted to receive data from said detection unit and to generate an alarm signal upon determination that the subject is in a drowning or near-drowning situation.

65. The apparatus of claim 64 further comprising a transmitter adapted to transmit said alarm signal and wherein said transmitter is adapted to transmit a radio frequency, a sonic or an ultrasonic alarm signal.

66. The apparatus of claim 64 further comprising a marker-releasing unit adapted to release a marker as said alarm signal said marker comprises a dye, a pigment, a coloring agent or any combination thereof.

67. The apparatus of claim 64, wherein said controller is further adapted to generate a wet alarm upon determination that the subject is in the water.

68. The apparatus of claim 64, further comprising a float unit adapted to be released from said apparatus upon indication from said controller of the subject being in a drowning or near-drowning situation.

69. The apparatus of claim 68, wherein said float unit comprises at least one of: a buoyancy canister to provide positive buoyancy, a transmitter adapted to transmit said alarm signal,
a marker-releasing unit adapted to release a marker as said alarm signal, a controller, a detecting unit, an antenna adapted to propagate said alarm signals, and a power source.

70. The apparatus of claim 64 wherein the detection unit comprises a water sensor, a movement sensor, a hydrostatic pressure sensor, a hydrodynamic pressure sensor a strain-gauge sensor, an inclinometer, a barometer, and combinations thereof.

71. The apparatus of claim 64 further comprises a release unit for releasably connecting the float unit to said apparatus, said release unit comprises an electro mechanical apparatus, a magnetic device, a mechanical device.

72. The apparatus of claim 64 further comprising a power source to provide electric power to said apparatus.

73. The apparatus of claim 64 further comprising an attachment unit adapted to attach said apparatus to the subject.

74. The apparatus of claim 68, further comprises a micro-switch adapted to activate said float unit consequent to separation from said apparatus.

75. The apparatus of claim 68 further comprising a base unit adapted to connect to an attachment unit and releasably connect to said float unit.

76. The apparatus of claim 75, wherein said base unit comprises a transmitter adapted to transmit said alarm signal, a marker-releasing unit adapted to release a marker as said alarm signal, a controller, antenna adapted to propagate said alarm signals, a power source and combinations thereof.

77. The apparatus of claim 64 further comprises a press-button adapted to test at least one function of said apparatus, a press-button adapted to release said float unit from said apparatus, a Global Positioning System adapted to provide information related to the location of the subject, and combinations thereof.

78. The apparatus of claim 64, wherein said apparatus is adapted to be attached to a wrist of the subject or to be an integral part of a water-proof wristwatch.

79. The apparatus of claim 64, wherein the controller adapted to receive data from said detection unit and to generate an alarm signal upon determination that the subject is in a drowning or near-drowning situation.

80. The apparatus of claim 64, wherein the detection unit is adapted to perform at least one of: identifying a passive movement of the subject, differentiating between an active movement of the subject and a passive movement of the subject associated by at least one of a wave or a current,
counting movements of the subject within pre-defined time periods, and determining that the subject is in a drowning or near-drowning situation if a number of movements within said pre-defined time period is smaller than a threshold value,
determining that a first number of movements occur within a first time period, and to determining that a second number of movements occur within a second time period, wherein the first time period and the second time period are substantially equal,
determining that the subject is in drowning or near-drowning situation based on a calculation taking into account at least the first number of movements and the second number of movements, determining that the subject is not in drowning or near-drowning situation if the second number of movements is smaller than the product of: the first number of movements multiplied by a pre-defined positive number greater than on, and combinations thereof.

81. A system for the detection of a subject in a drowning or near-drowning situation, the system comprising:
a wearable apparatus comprising a detection unit adapted to detect at least one body movement related parameter and at least one environmental parameter and a controller adapted to receive data from said detection unit and to generate an alarm signal upon determination that the subject is in a drowning or near-drowning situation; and
a receiver adapted to receive the alarm signal and to output an alarm upon receiving the alarm signal.

82. The system of claim 81, wherein said receiver is adapted to receive a radiofrequency signal, a sonic, an ultrasonic signal or any combination thereof and to transmit an alarm signal to a workstation, a remote receiver, or both in a wired or a wireless manner.

82. The system of claim 81, wherein said alarm comprises an audio alarm, a visual alarm, a vibration alarm or any combination thereof.

83. A method for the detection of a subject in a drowning or near-drowning situation, the method comprising:
detecting at least one body movement related parameter and at least one environmental parameter; and
generating an alarm signal upon determination that the subject is in a drowning or near-drowning situation.

84. The method of claim 83, further comprising releasing a float unit from the apparatus upon indication from the controller that the subject is being in a drowning or near-drowning situation.

85. The method of claim 83, further comprising either outputting the alarm to indicate that a subject is in a drowning or near-drowning situation, or transmitting the alarm signal to a receiver by radio frequency, sonic or ultrasonic technology alarm signal, or both, and wherein the alarm comprises an audio alarm, a visual alarm, a vibration alarm or any combination thereof.

86. The method of claim 85, further comprising transmitting an alarm signal from the receiver to a workstation, to a remote receiver or to both and outputting an alarm upon receiving the alarm signal in said workstation or remote receiver, or both to indicate that a subject is in a drowning or near-drowning situation.

87. The method of claim 83, further comprising releasing a marker-releasing unit to indicate that a subject is in a drowning or near-drowning situation, and wherein the marker-releasing unit comprises a dye, a pigment, a coloring agent or any combination thereof.
